(19) United States
(12) Patent Application Publication
(10) Pub. No.: US 2014/0326102 A1
(43) Pub. Date: Nov. 6, 2014

(54) HEV BRAKE PEDAL ASSEMBLY WITH PEDAL RETURN MECHANISM

(71) Applicants: Adil Khan, Windsor (CA); mark Warren Muddiman, Belleville, MI (US)

(72) Inventors: Adil Khan, Windsor (CA); mark Warren Muddiman, Belleville, MI (US)

(73) Assignee: FORD GLOBAL TECHNOLOGIES, LLC, DEARBORN, MI (US)

(21) Appl. No.: 13/875,191

(22) Filed: May 1, 2013

(51) Int. Cl. G05G 1/44

(52) U.S. Cl. CPC G05G 1/44
USPC 74/512

(57) ABSTRACT

A brake pedal assembly includes an assembly frame, a pedal arm pivotally carried by the assembly frame, a booster input rod, a booster washer carried by the booster input rod, a rod actuating element carried by the pedal arm and engaging the booster input rod and a biasing device interposed between the booster washer and the rod actuating element.

### FIELD

Illustrative embodiments of the disclosure generally relate to brake pedals for BBW (Brake By Wire) systems in vehicles. More particularly, illustrative embodiments of the disclosure relate to aBBW brake pedal assembly with a pedal return mechanism which provides a return force for a brake pedal and maintains hysteresis during return of the pedal to the release position.

### BACKGROUND

Conventional brake pedals for HEVs may include a foot-actuated brake pedal which pivotally engages a pedal arm. The pedal arm actuates a booster input rod through a booster washer on the rod. The booster input rod actuates the hydraulic brake booster to effect the friction braking operation of the vehicle. Accordingly, upon depression of the brake pedal from a release position to a braking position, the pedal arm pivots and pushes the booster input rod into the brake booster which applies hydraulic braking to the vehicle wheels.

One or a pair of pedal return springs may return the brake pedal to the release position after braking. A hysteresis mechanism on the brake pedal may provide hysteresis during return of the pedal such that the pedal imparts the feel of the brake pedal of a conventional vehicle braking system. The conventional HEV brake pedal design requires application of the hysteresis while a gap is maintained between the pedal arm and the booster washer on the booster input rod and as the pedal returns to the release position. However, this design may add costs to the design and manufacture of the brake pedal.

Accordingly, an HEV brake pedal assembly with a pedal return mechanism which provides a return force for a brake pedal and maintains hysteresis during return of the pedal to the release position is needed.

### SUMMARY

Illustrative embodiments of the disclosure are generally directed to a BBW actuation system. An illustrative embodiment of the brake pedal assembly includes an assembly frame, a pedal arm pivotally carried by the assembly frame, a booster input rod, a booster washer carried by the booster input rod, a rod actuating element carried by the pedal arm and engaged by the booster input rod and a biasing device interposed between the booster washer and the rod actuating element.

Illustrative embodiments of the disclosure are further generally directed to a brake pedal return method. An illustrative embodiment of the brake pedal return method includes inserting a biasing device between a booster washer and a rod actuating element on a booster input rod of a brake pedal assembly.

### BRIEF DESCRIPTION OF THE DRAWINGS

Illustrative embodiments of the disclosure will now be described, by way of example, with reference to the accompanying drawings, in which:

FIG. 1 is a side view of an illustrative embodiment of the BBW brake pedal assembly, with the brake pedal shown in a release position and a pedal return mechanism shown in an expanded position to maintain the brake pedal in the release position.

FIG. 1A is an enlarged side view, partially in section, of the pedal return mechanism of the illustrative BBW brake pedal assembly, shown in the expanded position.

FIG. 2 is a side view of an illustrative embodiment of the HEV brake pedal assembly, with the brake pedal shown in a braking position and the pedal return mechanism shown in a compressed position to actuate a booster input rod. Booster input rod is actuated by washer after gap (30) closure.

FIG. 2A is an enlarged side view, partially in section, of the pedal return mechanism, shown in the compressed position.

FIG. 3 is a flow diagram of a brake pedal return method.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the claims. Moreover, the illustrative embodiments described herein are not exhaustive and embodiments or implementations other than those which are described herein and which fall within the scope of the appended claims are possible. Furthermore, there is no intention to be bound by any expressed or implied theory presented in the preceding technical field, background, brief summary or the following detailed description.

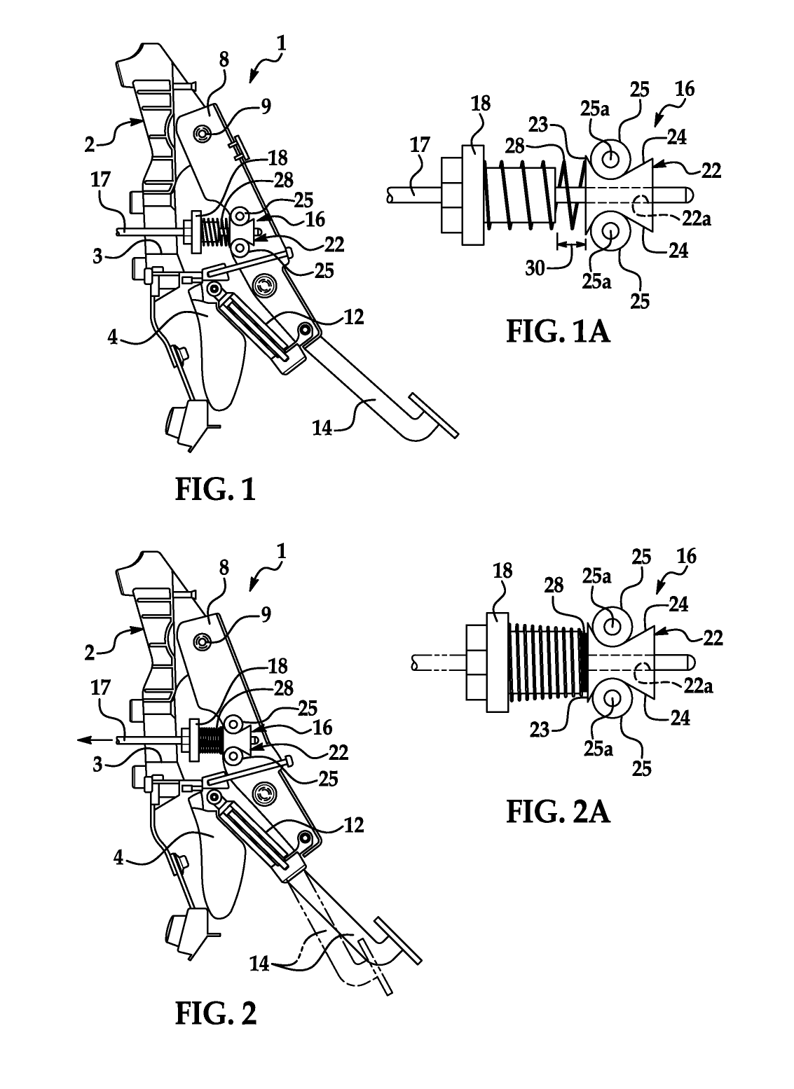

Referring to FIGS. 1, 1A, 2 and 2A, an illustrative embodiment of the BBW brake pedal assembly, hereinafter assembly, is generally indicated by reference numeral 1. The assembly 1 may include an assembly frame 2 which may be attached to the frame (not shown) of a vehicle using conventional methods. The assembly frame 2 may have a rod opening 3.

A pedal arm 8 may be pivotally attached to the pedal flanges 4 via a pedal arm pivot 9. At least one booster return spring 12 Upon release of the brake pedal 14 from the braking position of FIG. 2, the booster spring 12 along with the biasing spring 28 return the brake pedal 14 back to the release position of FIG. 1 typically in the conventional manner.

A pedal return mechanism 16 may include a booster input rod 17 which operatively engages a hydraulic brake booster (not shown) of the vehicle braking system. The booster input rod 17 may extend through the rod opening 3 in the assembly frame 2. A booster washer 18 may be provided in fixed position on the booster input rod 17. In some embodiments, the booster washer 18 may be threaded on the booster input rod 17.

A rod actuating element 22 may be provided on the pedal arm 8. The booster input rod 17 may freely extend through a pedal opening 22a in the rod actuating element 22. The rod actuating element 22 may include a spring engaging surface 23. When the brake pedal 14 is disposed in the release position, as shown in FIGS. 1 and 1A, a gap 30 is defined between the booster washer 18 and the spring engaging surface 23 of the rod actuating element 22.

A biasing device 28 is interposed between surfaces 18a of the booster washer 18 and the spring engaging surface 23 of the rod actuating element 22. The biasing device 28 may be any type of biasing mechanism which is suitable for returning the pedal arm 8 to the release position of FIG. 1 when the brake pedal 14 is not depressed. The biasing device 28 may include at least one coiled spring, at least one disk spring or any combination thereof, for example and without limitation.

In application of the assembly 1, the biasing device normally pushes the pedal arm 8 in the release position against the upstop bolt 30 as shown in FIG. 1. During braking of the vehicle, the vehicle operator (not shown) applies foot pressure to the brake pedal 14, pivoting the pedal arm 8 at the pedal arm pivot 9. The pedal arm 8 pushes the rod actuating element 22 along the booster input rod 17 toward the stationary booster washer 18, closing the gap 30 as shown in FIGS. 2 and 2A. When the biasing device 28 is maximally compressed between the rod actuating element 22 and the booster washer 18, as illustrated in FIG. 2A, the rod actuating element 22 pushes against the booster washer 18 which, in turn, pushes the booster input rod 17 into the hydraulic brake booster (not shown). The hydraulic brake booster delivers hydraulic pressure to the vehicle brakes (not shown), which apply friction braking to the vehicle wheels such as in the conventional manner.

Upon subsequent release of the brake pedal 14 at the conclusion of friction braking, the biasing device 28 expands and pushes the rod actuating element 22 on the booster input rod 17 away from the booster washer 18. The rod actuating element 22 pivots the pedal arm 8 and the brake pedal 14 back to the release position of FIG. 1 as the gap 30 between the booster washer 18 and the rod actuating element 22 is restored. Simultaneously, responsive to return force applied by the booster/master cylinder assembly (not shown) of the vehicle, the booster input rod 17 withdraws from the brake booster, which terminates friction braking at the vehicle wheels. As the vehicle operator releases the brake pedal 14, the return force of the booster input rod 17 may impart a hysteresis force to the brake pedal 14 via the booster washer 18, the biasing device 28, the rod actuating element 22 and the pedal arm 8. The booster spring or springs 12 may assist in returning the pedal arm 8 and the brake pedal 14 to the release position.

It will be appreciated by those skilled in the art that the pedal return mechanism 16 eliminates the need for a hysteresis mechanism to apply a hysteresis force to the brake pedal 14 as the brake pedal 14 returns to the release position. This expedient may result in cost savings to design and manufacture of the assembly 1. The biasing forces of the biasing device 28 and the booster springs 12 may need to be balanced so that both the return force for the brake pedal 14 is sufficient and the booster washer 18 does not actuate the booster input rod 17 before closure of the gap 30 or completion of the regenerative braking portion of the braking operation. The pedal return mechanism 16 can be retrofitted to existing vehicles by imposition of the biasing device 16 between the booster washer 18 and the rod actuating element 22. The conventional hysteresis mechanism (not shown) can be removed from the brake pedal 14 since the return force exerted by the booster input rod 17 provides a hysteresis force to the brake pedal 14.

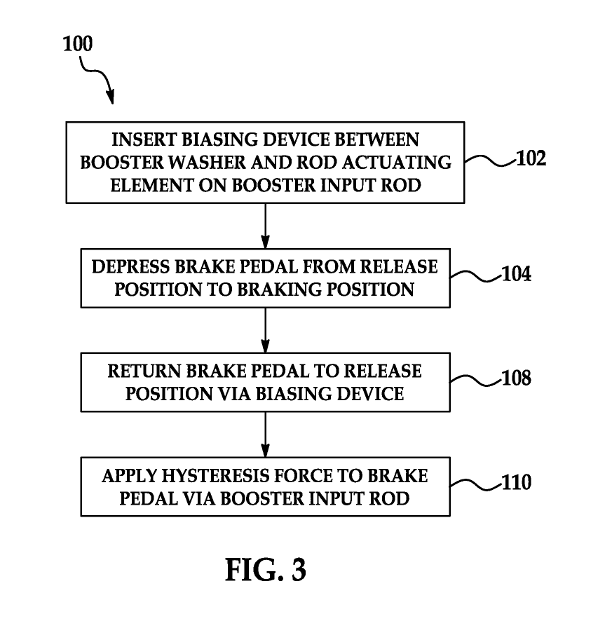

Referring next to FIG. 3, a flow diagram 100 of a brake pedal return method is shown. In block 102, a biasing device is inserted between a booster washer and a rod actuating element on a booster input rod of a BBW brake pedal assembly. The biasing device may include at least one coiled spring, at least one disk spring or any combination thereof, for example and without limitation. In block 104, the brake pedal is depressed from a release position to a braking position in friction braking of a vehicle. In block 106, the brake pedal returns to the release position via the biasing device. In block 108, upon return of the brake pedal to the brake release position, hysteresis is provided by the booster input rod as the return is damped due to the brake fluid in the master cylinder.

Although the embodiments of this disclosure have been described with respect to certain exemplary embodiments, it is to be understood that the specific embodiments are for purposes of illustration and not limitation, as other variations will occur to those of skill in the art.

What is claimed is:

1. A brake pedal assembly, comprising:
an assembly frame;
a pedal arm pivotally carried by the assembly frame;
a booster input rod;
a booster washer carried by the booster input rod;
a rod actuating element carried by the pedal arm and engaging the booster input rod; and
a biasing device interposed between the booster washer and the rod actuating element.

2. The brake pedal assembly of claim 1 wherein the biasing device comprises at least one coiled spring.

3. The brake pedal assembly of claim 1 wherein the biasing device comprises at least one disk spring.

4. The brake pedal assembly of claim 1 wherein the biasing device comprises at least one coiled spring and at least one disk spring.

5. The brake pedal assembly of claim 1 further comprising at least one booster spring normally biasing the pedal arm and the brake pedal in a release position.

6. The brake pedal assembly of claim 1 wherein the booster input rod applies a hysteresis force against the pedal arm.

7. A brake pedal assembly, comprising:
an assembly frame;
a pair of pedal flanges carried by the assembly frame;
a pedal arm pivotally carried by the pedal flanges;
a brake pedal and the pedal arm pivotal between a release position and a braking position;
a booster input rod;
a booster washer carried by the booster input rod;
a rod actuating element slidably carried by the booster input rod and engaged by the pedal arm;
a gap between the booster washer and the rod actuating element when the brake pedal and the pedal arm are disposed in the release position, the gap closed as the brake pedal and the pedal arm pivot from the release position to the braking position; and
a biasing device interposed between the booster washer and the rod actuating element.

8. The brake pedal assembly of claim 7 wherein the biasing device comprises at least one coiled spring.

9. The brake pedal assembly of claim 7 wherein the biasing device comprises at least one disk spring.

10. The brake pedal assembly of claim 7 wherein the biasing device comprises at least one coiled spring and at least one disk spring.

11. The brake pedal assembly of claim 7 further comprising at least one booster spring normally biasing the pedal arm and the brake pedal in a release position.

12. The brake pedal assembly of claim 7 wherein the booster input rod applies a hysteresis force against the pedal arm and the brake pedal.

13. A brake pedal return method, comprising:
inserting a biasing device between a booster washer and a rod actuating element on a booster input rod of a brake pedal assembly.

14. The method of claim 13 further comprising removing a hysteresis mechanism from a brake pedal of the brake pedal assembly.

15. The method of claim 14 further comprising depressing the brake pedal from a release position to a braking position.

16. The method of claim 15 further comprising imparting a hysteresis force to the brake pedal via the booster input rod.
